(19) United States
(12) Patent Application Publication
(10) Pub. No.: US 2024/0193610 A1
(43) Pub. Date: Jun. 13, 2024

(54) ELECTRONIC DATA MANAGEMENT FOR AN ASSET ASSOCIATED WITH A PROPERTY IDENTIFIER BASED ON A DISTRIBUTED LEDGER

(71) Applicant: Assurant, Inc., New York, NY (US)

(72) Inventor: Nathan Werner, Mukwonago, WI (US)

(21) Appl. No.: 18/533,695

(22) Filed: Dec. 8, 2023

Related U.S. Application Data
(60) Provisional application No. 63/386,689, filed on Dec. 9, 2022.

(51) Int. Cl. G06Q 20/40; G06Q 20/02; G06Q 20/06

(52) U.S. Cl. CPC G06Q 20/405; G06Q 20/02; G06Q 20/0655

(57) ABSTRACT

Embodiments of the present disclosure provide for electronic data management for an asset associated with a property identifier based on a distributed ledger. Such embodiments may include monitoring a data capture event stream that comprises electronic data for an asset associated with a property identifier. Such embodiments may additionally or alternatively include, in response to a change with respect to the data capture event stream, generate a candidate data block associated with a portion of the electronic data related to the change with respect to the data capture event stream. Such embodiments may additionally or alternatively include adding the candidate data block to a distributed ledger in accordance with a distributed ledger consensus protocol based on a comparison between the portion of the electronic data and one or more transaction validation rules. Such embodiments may additionally or alternatively include triggering one or more actions based on the distributed ledger.

### CROSS-REFERENCE TO RELATED APPLICATIONS

This application claims the benefit of and priority to U.S. Provisional Application No. 63/386,689, filed on Dec. 9, 2022, the entirety of which is hereby incorporated by reference herein.

### TECHNOLOGICAL FIELD

Embodiments of the present disclosure generally relate to automatically managing electronic data for an asset, and more particularly to automatically managing electronic data for an asset based on a distributed ledger.

### BACKGROUND

Data management systems generally rely on cumbersome and/or untrustworthy offline processes, such as manual interactions facilitated by users interacting with computing systems, to manage electronic data for an asset. However, Applicant has discovered problems with current implementations for managing electronic data for an asset. Through applied effort, ingenuity, and innovation, Applicant has solved many of these identified problems by developing embodied in the present disclosure, which are described in detail below.

### BRIEF SUMMARY

In an embodiment, an apparatus comprises one or more processors and one or more storage devices storing instructions that are operable, when executed by the one or more processors, to cause the one or more processors to monitor a data capture event stream that comprises electronic data for an asset associated with a property identifier. In response to a change with respect to the data capture event stream, the instructions are also operable, when executed by the one or more processors, to cause the one or more processors to generate a candidate data block associated with a portion of the electronic data related to the change with respect to the data capture event stream. The instructions are also operable, when executed by the one or more processors, to cause the one or more processors to add the candidate data block to a distributed ledger in accordance with a distributed ledger consensus protocol based on a comparison between the portion of the electronic data and one or more transaction validation rules. In one or more embodiments, the one or more transaction validation rules are configured based on one or more authorizations provided by a primary system and a secondary system. The instructions are also operable, when executed by the one or more processors, to cause the one or more processors to trigger one or more actions associated with the asset based on the distributed ledger.

In another embodiment, a computer-implemented method provides for monitoring a data capture event stream that comprises electronic data for an asset associated with a property identifier. In response to a change with respect to the data capture event stream, the computer-implemented method also provides for generating a candidate data block associated with a portion of the electronic data related to the change with respect to the data capture event stream. The computer-implemented method also provides for adding the candidate data block to a distributed ledger in accordance with a distributed ledger consensus protocol based on a comparison between the portion of the electronic data and one or more transaction validation rules. In one or more embodiments, the one or more transaction validation rules are configured based on one or more authorizations provided by a primary system and a secondary system. The computer-implemented method also provides for triggering one or more actions associated with the asset based on the distributed ledger.

In yet another embodiment, a computer program product is provided. The computer program product is stored on a computer readable medium, comprising instructions that when executed by one or more computers cause the one or more computers to monitor a data capture event stream that comprises electronic data for an asset associated with a property identifier. In response to a change with respect to the data capture event stream, the instructions, when executed by the one or more computers, also cause the one or more computers to generate a candidate data block associated with a portion of the electronic data related to the change with respect to the data capture event stream. The instructions, when executed by the one or more computers, also cause the one or more computers to add the candidate data block to a distributed ledger in accordance with a distributed ledger consensus protocol based on a comparison between the portion of the electronic data and one or more transaction validation rules. In one or more embodiments, the one or more transaction validation rules are configured based on one or more authorizations provided by a primary system and a secondary system. The instructions, when executed by the one or more computers, also cause the one or more computers to trigger one or more actions associated with the asset based on the distributed ledger.

Various other embodiments are also described in the following detailed description and in the attached claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced. Having thus described the embodiments of the disclosure in general terms, reference now will be made to the accompanying drawings, which are not necessarily drawn to scale, and wherein:

FIG. 1 illustrates a block diagram of a system that may be specially configured within which at least one example embodiment of the present disclosure may operate;

FIG. 2 illustrates a block diagram of an example apparatus that may be specially configured in accordance with at least one example embodiment of the present disclosure;

FIG. 3 illustrates an example data flow system as part of a process for managing electronic data for an asset associated with a property identifier based on a distributed ledger in accordance with at least one example embodiment of the present disclosure;

FIG. 4 illustrates a process depicting example operations of an example process for managing electronic data for an asset associated with a property identifier based on a distributed ledger in accordance with at least one embodiment of the present disclosure;

FIG. 5 illustrates a process 500 depicting example operations of an example process for managing digital tokens related to electronic data for an asset associated with a property identifier in accordance with at least one embodiment of the present disclosure;

FIG. 6A illustrates an example diagram of a system that can be used to practice one or more embodiments of the present disclosure; and

FIG. 6B illustrates an example diagram of another system that can be used to practice one or more embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

In various circumstances, various computing systems intersect to manage electronic data for an asset and/or to perform particular actions based on the electronic data for the asset. However, management of electronic data and/or actions related to the electronic data often present operational and technical challenges that make such interactions cumbersome, inefficient, or in certain contexts impossible. For example, in several contexts, each computing system is associated with independent and generally untethered systems that manage electronic data without knowledge of actions by other computing systems with respect to the electronic data. Such system arrangements make coordinated and automatic initiation of particular actions difficult, and even in circumstances where individual systems are configured to communicate automatically such systems may be vulnerable to inefficient usage of computing resources to manage the electronic data, vulnerabilities in validating electronic data, and/or any of a myriad of related technical problems. Such technical problems pose a particular threat in highly-secured or regulated environments, for example in contexts that rely on secure management of electronic data and/or related actions for an asset. Moreover, computing systems have not been capable of handling such management of electronic data for assets at scale (e.g., hundreds or thousands per day) without solutions according to the various embodiments herein.

To account for such technical problems, some implementations often rely on processes that are wholly offline and require tedious verification and inefficient computations to manage electronic data for an asset. For example, in several contexts, a multi-actor process may generate and/or utilize one or more portions of electronic data for an asset document(s) that are subsequently transferred to a different computing system responsible for performing a subsequent step in the process by parsing the electronic data into the overall instruction flow. This process may continue until each computing system has performed a respective action and the process completes. Such processes suffer from a myriad of their own problems, however, including significant inefficiencies, error(s), oversight, or misconduct, and/or lack of trust between computing systems and risk of fraudulent materials from malicious computing system. Additionally, in some instances, at least some electronic data for an asset may be reliant on human input to create, parse, and/or transfer certain electronic data, which may exacerbate existing inefficiencies.

In this regard, the inventors have identified that a computer-implemented approach that employs a distributed ledger is desirable to resolve and/or improve each of the circumstances described. In this regard, embodiments of the present disclosure resolve and/or improve such circumstances, including to provide for both improvements in efficiency as well as reductions in error, inconsistencies, and/or other problems associated with existing manual and/or attempted computer-implemented processes.

Embodiments of the present disclosure provide for electronic data management for an asset associated with a property identifier based on a distributed ledger. The electronic data management disclosed herein is at least partially automatic and secure by employing a distributed ledger in a manner that significantly reduces, or eliminates, reliance on human actors at least by a trusted entity serving as a manager between two other entities. Rather than relying on human actors to add electronic data to a data repository, the electronic data management disclosed herein can also provide a decentralized data management platform via the distributed ledger to provide improved traceability, trust, security, and/or quality of electronic data. In various embodiments, the electronic data management disclosed herein can add electronic data to the distributed ledger via extraction of the electronic data from data transmissions embodied via application programming interfaces (APIs) and/or by employing transaction validation rules for the distributed ledger. The transaction validation rules can manage updating, modifying, and/or adding electronic data to the distributed ledger. The transaction validation rules can additionally manage ownership of the electronic data to facilitate updating, modifying, and/or adding electronic data to the distributed ledger.

The electronic data management disclosed herein can additionally manage generation of the data transmissions via the APIs based on a credentials rule set to provide automated augmentation of electronic data to the distributed ledger. Some embodiments, when initiated, automatically identify particular electronic data via a privileged communication link that maintains secure and authenticated communication with a distributed ledger via the APIs to manage the electronic data for the asset. The decentralized features of the electronic data management disclosed herein can also allow searching and/or a real-time status of data objects for electronic data stored via the distributed ledger, as well as functionality to provide a historical status of data objects for electronic data stored via the distributed ledger. The searching, real-time status, and/or historical status for electronic data can be provided via APIs and/or electronic interfaces for user devices authorized via the credentials rule set.

The electronic data management based on a distributed ledger disclosed herein can additionally or alternatively provide one or more other improved efficiencies over separate, decentralized computing resources. Such improvements may include, but are not limited to; reduced processor loads and server requirements by centralizing numerous previously distributed and duplicative functions; centralized messaging services; swappable, modular computing resources that cause little to no downtime for any other computing resource when modified, added, or removed; a holistic data management environment facilitating improved processing of a data capture event stream and improved delivery of services to the user; reduced transaction time for both providers and end users; rapidly deployable computing resource sets and reduced set-wide development time with minimal to no effect on the development cycles of the underlying computing resources; more rapid computing resource development time with a distributed ledger integrated with the primary system; improved user device experience; higher service performance for the user with unique, customizable combinations of distinct computing resources; and the like.

### Example Systems

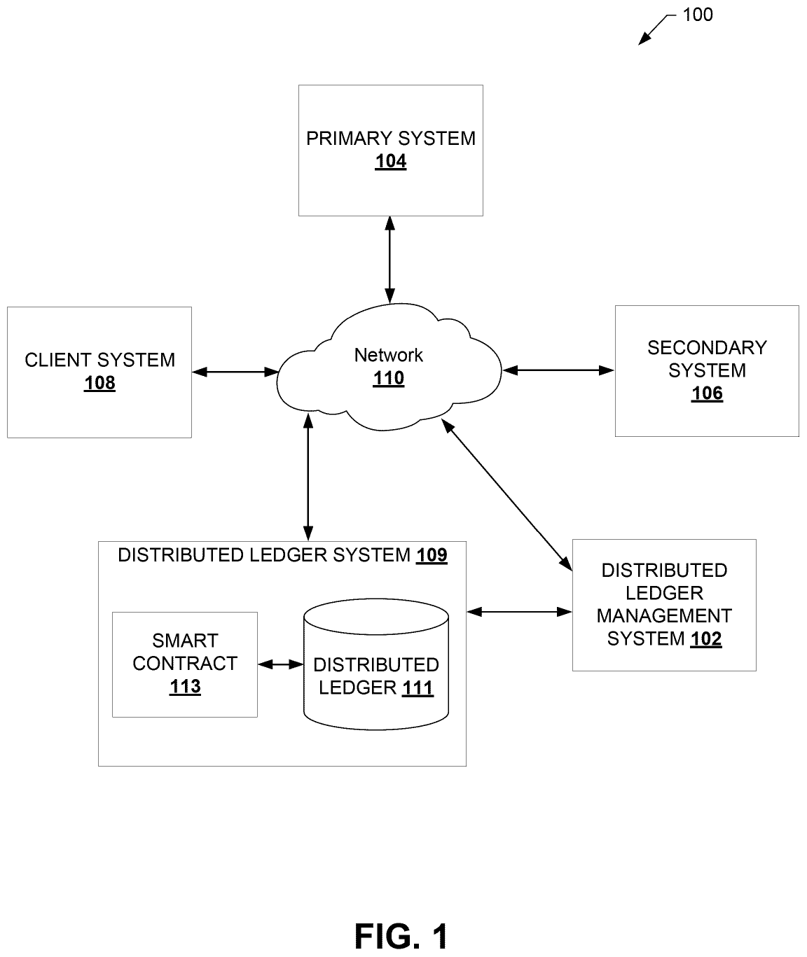

FIG. 1 illustrates a block diagram of a system that may be specially configured within which embodiments of the present disclosure may operate. Specifically, FIG. 1 illustrates an example system 100. The example system 100 includes at least a distributed ledger management system 102, primary system 104, a secondary system 106, a client system 108, and/or a distributed ledger system 109. In one or more embodiments, the system 100 includes at least one communications network 110 that enables transmission of data between one or more subsystem(s) and/or device(s) of the system 100. In one or more embodiments, the distributed ledger system 109 includes a distributed ledger 111 and/or a smart contract 113. The distributed ledger 111 can be a database that is distributed and/or synchronized across multiple network nodes such as, for example, multiple node computing entities. In certain embodiments, the distributed ledger 111 can be a blockchain.

The distributed ledger management system 102 includes one or more computer(s) embodied in hardware, software, firmware, and/or a combination thereof. In some embodiments, the distributed ledger management system 102 includes one or more application server(s), database server(s), enterprise computing terminal(s), and/or the like that are configured to perform the functionality described herein. In some embodiments, the distributed ledger management system 102 embodies or includes a backend system (e.g., one or more enterprise server(s)) that are communicable over one or more network(s) (e.g., via the Internet). Additionally or alternatively, in some embodiments, the distributed ledger management system 102 includes one or more virtual computer(s) embodied in a software environment maintained via particular hardware, for example where the distributed ledger management system 102 is maintained as a virtual environment on hardware of a central terminal supporting multiple software application(s). In some embodiments, the distributed ledger management system 102 includes one or more hardware device(s) within the same physically defined space, such as a data warehouse, company headquarters, and/or the like associated with a particular entity. Alternatively or additionally, in some embodiments, the distributed ledger management system 102 includes one or more hardware and/or software device(s) located remotely from one another and that communicate in conjunction with one another to provide the described functionality, for example embodied by one or more cloud computing system(s).

In some embodiments, the distributed ledger management system 102 includes a plurality of sub-services that each support a portion of the functionality performed by the distributed ledger management system 102. In some such embodiments, the plurality of sub-services may each be embodied by different hardware, software, firmware, and/or any combination thereof. Alternatively or additionally, in some embodiments, one or more of the sub-services share particular hardware, software, firmware, and/or any combination thereof. For example, in some embodiments, the distributed ledger management system 102 embody specially-configured software applications executed on shared hardware.

In some embodiments, the distributed ledger management system 102 supports a trusted multi-actor distributed ledger process for managing electronic data for one or more assets. For example, in some embodiments the distributed ledger management system 102 supports functionality for monitoring a data capture event stream that comprises electronic data for an asset associated with a property identifier. In some embodiments, in response to a change with respect to the data capture event stream, the distributed ledger management system 102 supports functionality for generating a candidate data block associated with a portion of the electronic data related to the change with respect to the data capture event stream. Additionally or alternatively, in some embodiments, the distributed ledger management system 102 supports adding the candidate data block to the distributed ledger 111 in accordance with a distributed ledger consensus protocol based on a comparison between the portion of the electronic data and one or more transaction validation rules. The one or more transaction validation rules can be configured based on one or more authorizations provided by the primary system 104, the secondary system 106, and/or the client system 108. Additionally or alternatively, in some embodiments, the distributed ledger management system 102 supports triggering one or more actions associated with the asset based on the distributed ledger 111.

In some embodiments, the distributed ledger management system 102 provides such functionality associated with a client system 108. In some embodiments, the client system 108 is associated with an asset and/or a related property identifier for the asset. In some embodiments, the client system 108 embodies a user device and/or end terminal accessible by a user to initiate functionality via the distributed ledger management system 102. For example, in some embodiments, a user enters authentication credentials via the client system 108 that are validated to initiate an authenticated session associated with the distributed ledger management system 102, such that the user may utilize the client system 108 to access functionality of the distributed ledger management system 102 associated with an asset profile and/or data associated therewith. The client system 108 in some embodiments is utilized to initiate one or more indication(s) of a trusted processing request. Additionally or alternatively, in some embodiments, the client system 108 is utilized to render user interface(s) that provide details associated with a distributed ledger data object associated with the distributed ledger 111, available resource data, available period(s), and/or the like. In some such embodiments, the client system 108 operates as a front-end or user-facing application for accessing such functionality of the distributed ledger management system 102.

The primary system 104 includes one or more computer(s) embodied in hardware, software, firmware, and/or a combination thereof. In some embodiments, the primary system 104 includes one or more application server(s), database server(s), enterprise computing terminal(s), and/or the like that are configured to perform the functionality described herein. Additionally or alternatively, in some embodiments, the primary system 104 includes one or more virtual computer(s) embodied in a software environment maintained via particular hardware, for example where the primary system 104 is maintained as a virtual environment on hardware of a central terminal supporting multiple software application(s). In some embodiments, the primary system 104 includes one or more hardware device(s) within the same physically defined space, such as a data warehouse, company headquarters, and/or the like, associated with a particular entity. Alternatively or additionally, in some embodiments, the primary system 104 includes one or more hardware and/or software device(s) located remotely from one another and that communicate in conjunction with one another to provide the described functionality, for example embodied by one or more cloud computing system(s).

In some embodiments, the primary system 104 supports a computer-implemented process for managing insurance information, mortgage information, banking information, and/or other information related to one or more accounts associated with one or more assets. For example, in some embodiments, the primary system 104 embodies or includes at least one insurance system, mortgage system, or banking system that maintains an account for a particular asset, and that is controllable via instructions from a different, third-party entity such as the distributed ledger management system 102.

In some embodiments, the primary system 104 supports automatically receiving data transmissions, for example embodied by API request(s), procedure call(s), and/or other digital data transfers, that embody a transfer request, such that the primary system 104 may automatically process such request(s). Additionally or alternatively, in some embodiments, the primary system 104 supports inputting (e.g., automatically via scanning or manually via user interface input for example) of a document embodying a transfer request transmitted to the primary system via digital mechanism(s) (e.g., email, FTP, and/or the like) or via offline means (e.g., postal mail, hand delivery, and/or the like).

Non-limiting examples of the primary system 104 includes an insurance carrier system that maintains accounts associated with insurance account information for various assets associated with respective property identifiers, a mortgage company system that maintains accounts associated with mortgage account information for various assets associated with respective property identifiers, a banking system that maintains accounts associated with bank account information for various assets associated with respective property identifiers, or another type of system that maintains accounts associated with account information for various assets associated with respective property identifiers. In some embodiments, the primary system 104 may be part of or within the same system as the distributed ledger management system 102. In some embodiments, the primary system 104 may be a distinct system operated by a different entity than the distributed ledger management system 102. The separate distributed ledger management system 102 may, in either event, control at least a portion of the operation of the primary system 104.

The secondary system 106 includes one or more computer(s) embodied in hardware, software, firmware, and/or a combination thereof. In some embodiments, the secondary system 106 includes one or more application server(s), database server(s), enterprise computing terminal(s), and/or the like that are configured to perform the functionality described herein. Additionally or alternatively, in some embodiments, the secondary system 106 includes one or more virtual computer(s) embodied in a software environment maintained via particular hardware, for example where the secondary system 106 is maintained as a virtual environment on hardware of a central terminal supporting multiple software application(s). In some embodiments, the secondary system 106 includes one or more hardware device(s) within the same physically defined space, such as a data warehouse, company headquarters, and/or the like, associated with a particular entity. Alternatively or additionally, in some embodiments, the secondary system 106 includes one or more hardware and/or software device(s) located remotely from one another and that communicate in conjunction with one another to provide the described functionality, for example embodied by one or more cloud computing system(s). In some embodiments, the secondary system 106 is embodied by the same system as the primary system 104, a subsystem of the primary system 104, and/or as part of the distributed ledger management system 102.

In some embodiments, the secondary system 106 supports a computer-implemented process for managing insurance information, mortgage information, banking information, and/or other information related to one or more accounts associated with one or more assets. For example, in some embodiments, the secondary system 106 embodies or includes at least one insurance system, mortgage system, or banking system that maintains an account for a particular asset, and that is controllable via instructions from a different, third-party entity such as the distributed ledger management system 102.

In some embodiments, the secondary system 106 supports automatically receiving data transmissions, for example embodied by API request(s), procedure call(s), and/or other digital data transfers, that embody a transfer request, such that the secondary system 106 may automatically process such request(s). Additionally or alternatively, in some embodiments, the secondary system 106 supports inputting (e.g., automatically via scanning or manually via user interface input for example) of a document embodying a transfer request transmitted to the primary system via digital mechanism(s) (e.g., email, FTP, and/or the like) or via offline means (e.g., postal mail, hand delivery, and/or the like).

Non-limiting examples of the secondary system 106 includes an insurance carrier system that maintains accounts associated with insurance account information for various assets associated with respective property identifiers, a mortgage company system that maintains accounts associated with mortgage account information for various assets associated with respective property identifiers, a banking system that maintains accounts associated with bank account information for various assets associated with respective property identifiers, or another type of system that maintains accounts associated with account information for various assets associated with respective property identifiers. In some embodiments, the secondary system 106 may be part of or within the same system as the distributed ledger management system 102. In some embodiments, the secondary system 106 may be a distinct system operated by a different entity than the distributed ledger management system 102. The separate distributed ledger management system 102 may, in either event, control at least a portion of the operation of the secondary system 106.

In some embodiments, the primary system 104 and the secondary system 106 are controlled by the same entity, for example the same bank. In other embodiments, different entities control each of the primary system 104 and the secondary system 106. It will be appreciated that the primary system 104 and secondary system 106 may communicate via a different communications network than the remaining components of the system 100, for example via SWIFT, an intranet, and/or the like that maintains security between the participating systems. In some embodiments, multiple primary systems 104, multiple secondary systems 106, and/or multiple client system 108 may be in communication with the other various computing systems.

The communications network 110 is configurable to be embodied in any of a myriad of network configurations. In some embodiments, the communications network 110 embodies a public network (e.g., the Internet). In some embodiments, the communications network 110 embodies a private network (e.g., an internal, localized, or closed-off network between particular devices). In some other embodiments, the communications network 110 embodies a hybrid network (e.g., a network enabling internal communication between particular connected devices and external communication with other devices). The communications network 110 in some embodiments includes one or more base station(s), relay(s), router(s), switch(es), cell tower(s), communications cable(s) and/or associated routing station(s), and/or the like. In some embodiments, the communications network 110 includes one or more computing device(s) controlled by individual entities (e.g., an entity-owner router and/or modem) and/or one or more external utility devices (e.g., Internet service provider communication tower(s) and/or other device(s)).

The computing devices of the system 100 may each communicate in whole or in part over a portion of one or more communication network(s), such as the communications network 110. For example, each of the components of the system 100 may be communicatively coupled to transmit data to and/or receive data from one another over the same and/or different wireless or wired networks embodying the communications network 110. Non-limiting examples of network configuration(s) for the communications network 110 include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively or additionally still, in some embodiments the communications network 110 enables communication to one or more other computing device(s) not depicted, for example client device(s) for accessing functionality of any of the subsystems therein via native and/or web-based application(s), and/or the like.

### Example Apparatus

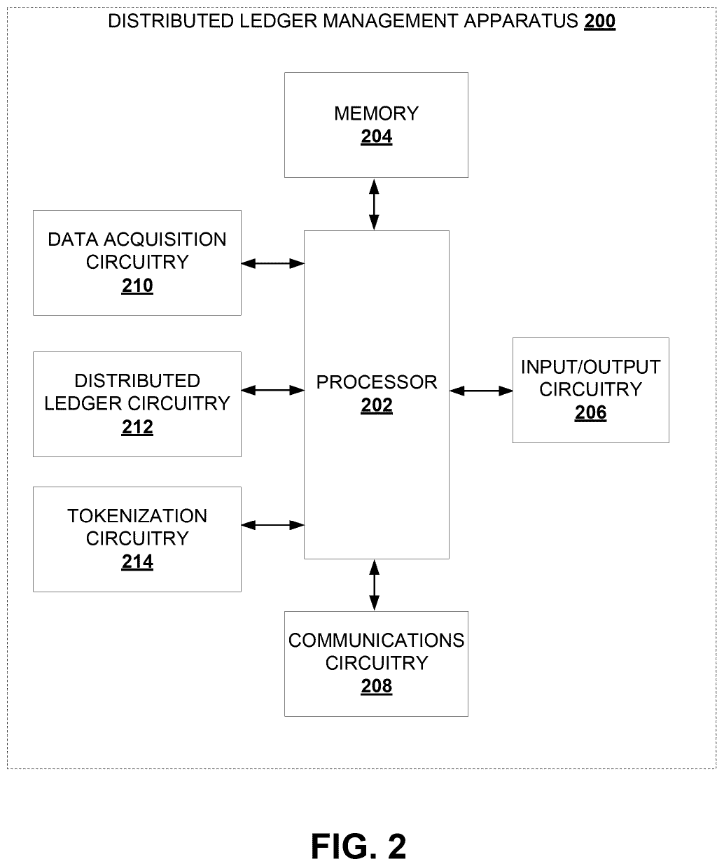

FIG. 2 illustrates a block diagram of an example apparatus that may be specially configured in accordance with at least one example embodiment of the present disclosure. Specifically, FIG. 2 illustrates an example distributed ledger management apparatus 200 (“apparatus 200”) specially configured in accordance with at least one example embodiment of the present disclosure. In some embodiments, the distributed ledger management system 102, and/or a portion thereof, is embodied by one or more system(s), device(s), and/or the like, such as the distributed ledger management apparatus 200 as depicted and described in FIG. 2. The distributed ledger management apparatus 200 includes processor 202, memory 204, input/output circuitry 206, communications circuitry 208, data acquisition circuitry 210, distributed ledger circuitry 212, and tokenization circuitry 214. In some embodiments, the distributed ledger management apparatus 200 is configured, using one or more of the sets of circuitry 202, 204, 206, 208, 210, 212, and/or 214, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the distributed ledger management apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the distributed ledger management apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the distributed ledger management apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the distributed ledger management apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the distributed ledger management apparatus 200, and/or one or more remote or “cloud” processor(s) external to the distributed ledger management apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the distributed ledger management apparatus 200 includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the distributed ledger management apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the distributed ledger management apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the distributed ledger management apparatus 200.

In some embodiments, the distributed ledger management apparatus 200 includes data acquisition circuitry 210. The data acquisition circuitry 210 includes hardware, software, firmware, and/or a combination thereof, that supports various functionality associated with monitoring and/or acquiring electronic data associated with one or more assets. For example, in some embodiments, the data acquisition circuitry 210 includes hardware, software, firmware, and/or a combination thereof, that monitors a data capture event stream that comprises electronic data for an asset associated with a property identifier. Additionally or alternatively, in some embodiments, the data acquisition circuitry 210 includes hardware, software, firmware, and/or a combination thereof, that enables access to one or more API(s), FTP connection(s), and/or the like to securely monitor, acquire, receive, retrieve, and/or otherwise identify electronic data from one or more system(s) external from the distributed ledger management apparatus 200. Additionally or alternatively, in some embodiments, the data acquisition circuitry 210 includes hardware, software, firmware, and/or a combination thereof, that, in response to a change with respect to the data capture event stream, generates a candidate data block associated with a portion of the electronic data related to the change with respect to the data capture event stream. In some embodiments, the data acquisition circuitry 210 includes a separate processor, specially configured field programmable gate array (FPGA), or a specially programmed application specific integrated circuit (ASIC).

In some embodiments, the distributed ledger management apparatus 200 includes distributed ledger circuitry 212. The distributed ledger circuitry 212 includes hardware, software, firmware, and/or a combination thereof, that supports various functionality associated with automatically managing a distributed ledger and/or performing actions with respect to the distributed ledger 111. For example, in some embodiments, the distributed ledger circuitry 212 includes hardware, software, firmware, and/or a combination thereof, that adds the candidate data block to the distributed ledger 111 in accordance with a distributed ledger consensus protocol based on a comparison between the portion of the electronic data and one or more transaction validation rules. The one or more transaction validation rules can be configured based on one or more authorizations provided by the primary system 104, the secondary system 106, and/or the client system 108. In some embodiments, the distributed ledger circuitry 212 includes a separate processor, specially configured FPGA, or a specially programmed ASIC.

In some embodiments, the distributed ledger management apparatus 200 includes tokenization circuitry 214. The tokenization circuitry 214 includes hardware, software, firmware, and/or a combination thereof, that supports various functionality associated with managing digital tokens associated with the distributed ledger 111. In some embodiments, the tokenization circuitry 214 includes a separate processor, specially configured FPGA, or a specially programmed ASIC.

Additionally or alternatively, in some embodiments, two or more of the sets of circuitries 202-214 are combinable. Alternatively or additionally, in some embodiments, one or more of the sets of circuitry perform some or all of the functionality described associated with another component. For example, in some embodiments, two or more of the sets of circuitry 202-214 are combined into a single module embodied in hardware, software, firmware, and/or a combination thereof. Similarly, in some embodiments, one or more of the sets of circuitry, for example the data acquisition circuitry 210, distributed ledger circuitry 212, and/or tokenization circuitry 214, is/are combined with the processor 202, such that the processor 202 performs one or more of the operations described above with respect to each of these sets of circuitry 210-214.

### Example Ledger Management

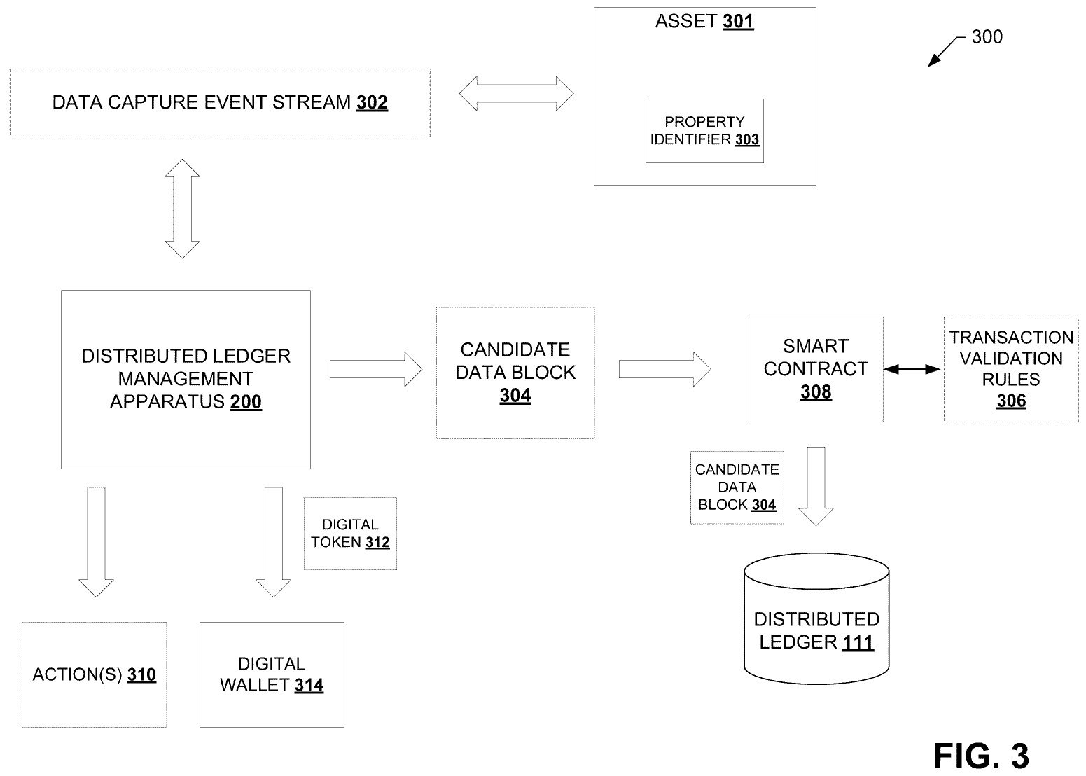

FIG. 3 illustrates an example data flow system 300 as part of a process for managing electronic data for an asset associated with a property identifier based on a distributed ledger in accordance with at least one example embodiment of the present disclosure. Specifically, the data flow system 300 depicts functionality between the various sub-systems of the system 100, including the distributed ledger management apparatus 200 and the distributed ledger 111. It should be appreciated that, as described herein, the distributed ledger management system 102 in some embodiments is embodied by the distributed ledger management apparatus 200.

The data acquisition circuitry 210 (shown in FIG. 2) can include hardware, software, firmware, and/or a combination thereof, that monitors a data capture event stream 302. The data capture event stream 302 can comprises electronic data for an asset 301 associated with a property identifier 303. The electronic data can include document data, email data, fax data, electronic message data, notification data, electronic data interchange (EDI) data, communication channel data, API data, report data, text recognition data, voice recognition data, optical character recognition (OCR) data, text-to-speech data, sensor data, metadata, and/or other data. In an embodiment, the data capture event stream 302 can be an event stream that aggregates data from multiple data sources such as the primary system 104, the secondary system 106, and/or the client system 108. Alternatively, the data capture event stream 302 can be configured as two or more event streams that respectively aggregates data from a respective data source such as the primary system 104, the secondary system 106, and/or the client system 108.

In certain embodiments, the data acquisition circuitry 210 can transmit one or more data requests to a data source such as the primary system 104, the secondary system 106, and/or the client system 108 to request electronic data for the data capture event stream 302. For example, a predefined data stack composition of a plurality of data types (e.g., protection data and rights data) may be screened for one or more of a plurality of property identifiers and data may be requested in an instance in which the plurality of data types are not populated. For example, based on monitoring of data included in the distributed ledger 111, a determination that a portion of data is missing from the distributed ledger 111, a determination that a portion of data stored by the distributed ledger 111 has changed, and/or a determination that a certain event has occurred with respect to the distributed ledger 111, the data acquisition circuitry 210 can transmit one or more data requests to a data source such as the primary system 104, the secondary system 106, and/or the client system 108 to request additional data for storage via the distributed ledger 111. In some embodiments, the data requests may be linked with a token to incentivize data contributions as described further herein. In certain embodiments, the data acquisition circuitry 210 can transmit one or more data requests to a data source such as the primary system 104, the secondary system 106, and/or the client system 108 based on one or more actions performed via a user interface and/or another input mechanism associated with the input/output circuitry 206.

At least a portion of the electronic data can be pre-processed by one or more data sources and/or one or more systems external from the distributed ledger management apparatus 200. For example, at least a portion of the electronic data can be pre-processed by the primary system 104, the secondary system 106, and/or the client system 108 to provide text recognition data, voice recognition data, OCR data, text-to-speech data, and/or other processed data. Additionally or alternatively, at least a portion of the electronic data can be processed by the data acquisition circuitry 210 to provide text recognition data, voice recognition data, OCR data, text-to-speech data, and/or other processed data. For example, the data acquisition circuitry 210 can be configured to perform natural language processing, data classification, pattern recognition, text recognition, one or more OCR processes, and/or one or more other techniques to process data. In certain embodiments, the data acquisition circuitry 210 can employ one or more machine learning models to perform natural language processing, data classification, pattern recognition, text recognition, one or more OCR processes, and/or one or more other techniques to process data. The asset 301 can be, but is not limited to, a house, a plot, an apartment, a condo, a townhouse, a building, a vehicle, a car, an airplane, a boat, a device, equipment, industrial equipment, farming equipment, an electronic device, a user device, a smartphone, a computer, a laptop, a tablet computer, a wearable device, a virtual reality device, an augmented reality device, a server farm, or another type of asset associated with a property identifier. In various embodiments, one or more systems may utilize the property identifier to add data to the distributed ledger independently, such that a full data stack associated with the property identifier may be collected from one or more sources (e.g., a plurality of sources, such as an insurance company and a bank) via any means disclosed herein.

The property identifier 303 can identify the asset 301. For example, the property identifier 303 can be and/or can correlate to a sequence of formatted data such as a mailing address of a house asset. In one or more embodiments, the property identifier 303 can be configured as one or more items of data by which the asset 301 may be uniquely identified. For example, the property identifier 303 can correspond to a particular set of bits or a particular sequence of data that uniquely identifies the asset 301. In various embodiments, the asset 301 and/or the property identifier 303 is authorized by the distributed ledger management system 102 such that electronic data associated with the asset 301 and/or the property identifier 303 is capable of being added to the distributed ledger 111. In some such embodiments, the one or more portions of the data capture event stream 302 may occur via data transmissions between such subsystems over one or more communications networks, for example the communications network 110. In certain embodiments, the data acquisition circuitry 210 can monitor and/or determine events such as, for example, protection deficit events, associated with the property identifier 303 to provide monitoring and/or resolution of potential traceability, trust, security, and/or quality issues related to electronic data for the asset 301.

In various embodiments, in response to a change with respect to the data capture event stream 302, the data acquisition circuitry 210 can include hardware, software, firmware, and/or a combination thereof, that generates a candidate data block 304. The candidate data block 304 can be associated with a portion of the electronic data related to the change with respect to the data capture event stream 302. Additionally, the distributed ledger circuitry 212 can include hardware, software, firmware, and/or a combination thereof, that adds the candidate data block 304 to the distributed ledger 111 in accordance with a distributed ledger consensus protocol based on a comparison between the portion of the electronic data in the candidate data block 304 and one or more transaction validation rules 306.

The distributed ledger consensus protocol can be a consensus mechanism of the distributed ledger 111 such as, for example, a proof-of-work protocol, that provides decentralized functionality for the distributed ledger 111. For example, the distributed ledger consensus protocol can be a proof-of-work protocol, a blockchain consensus protocol, or another type of consensus protocol such that computing nodes of a distributed ledger network for the distributed ledger 111 can reach a common agreement as to the authorization candidate data blocks for the distributed ledger 111.

In certain embodiments, the one or more transaction validation rules 306 can be configured a digital key for the distributed ledger 111. A transaction validation rule from the one or more transaction validation rules 306 can be a rule related to adding candidate data blocks and/or other data structures to the distributed ledger 111. In certain embodiments, transaction validation rule from the one or more transaction validation rules 306 can correspond to a predefined rule associated with a predefined event and/or a predefined action related to electronic data for the asset 301. A predefined event or action can corresponds to a predefined type of transaction such as a protection data event (e.g., a change, addition, or removal of protection data—such as removing home protection coverage), a rights data event (e.g., a change, addition, or removal of rights data—such as changing ownership or mortgage rights), a predefined type of policy change, a predefined type of coverage, a predefined type of renewal or cancelation of a policy, a predefined type of payee change, a predefined type of lender-placed insurance (LPI) event, a predefined type of mortgagee clause change, a predefined type of payoff event, a predefined type of loan change, a predefined type of consent, a predefined type of notice, and/or another type of predefined event or action related to the primary system 104 and/or the secondary system 106.

Additionally, transaction validation rule from the one or more transaction validation rules 306 can define criteria for initiating execution of a set of instructions for analyzing electronic data for potential addition to the distributed ledger 111. In various embodiments, a transaction validation rule from the one or more transaction validation rules 306 can be determined based on one or more owners (e.g., a decentralized autonomous organization) such as the distributed ledger management system 102, the primary system 104, and/or the secondary system 106. In certain embodiments, a transaction validation rule from the one or more transaction validation rules 306 can initiate generation of a digital token for a predefined event and/or a candidate data block added to the distributed ledger 111.

In certain embodiments, the distributed ledger circuitry 212 can include hardware, software, firmware, and/or a combination thereof, that cause execution of a smart contract 308 of the distributed ledger 111 to add the candidate data block 304 to the distributed ledger 111 in accordance with the distributed ledger consensus protocol. In certain embodiments, the one or more transaction validation rules 306 can be predefined rules embedded into the smart contract 112 such that a candidate data block is authorized to be added to the distributed ledger 111 in response to the one or more transaction validation rules 306 being satisfied.

In various embodiments, the candidate data block 304 added to the distributed ledger 111 can include one or more portions of the electronic data associated with the data capture event stream 302, the property identifier 303 for the asset 301, a user identifier (e.g., an owner) associated with the asset 301, mortgage information for the asset 301, insurance coverage information for the asset 301, banking information for the asset 301, mortgagee clause information for the asset 301, payee information for the asset 301, a timestamp associated with the change with respect to the data capture event stream 302, network node information associated with the data capture event stream 302, network node information associated with the distributed ledger 111, data analytics information associated with the change with respect to the data capture event stream 302, transaction information related to the electronic data, change details related to the electronic data, metadata, and/or other data.

In certain embodiments, the distributed ledger circuitry 212 can include hardware, software, firmware, and/or a combination thereof, that trigger one or more actions 310 associated with the asset 301 based on the distributed ledger 111. For example, the distributed ledger circuitry 212 can include hardware, software, firmware, and/or a combination thereof, that renders visualization data associated with data included in the candidate data block 304 via an electronic interface of the client system 108 or another computing device. In another example, the distributed ledger circuitry 212 can include hardware, software, firmware, and/or a combination thereof, that generates one or more notifications associated with data included in the candidate data block 304 for the client system 108 or another computing device. In another example, the distributed ledger circuitry 212 can include hardware, software, firmware, and/or a combination thereof, that triggers one or more API calls associated with data included in the candidate data block 304 for the client system 108 or another computing device. The one or more API calls can be related to the primary system 104, the secondary system 106, and/or the client system 108.

In some embodiments, the electronic interface is rendered as part of a particular application accessible via the client system 108. In some such embodiments, the application may embody a user-facing application providing access to functionality of the distributed ledger management system 102. Alternatively or additionally, in some embodiments, the electronic interface is renderable within a web application that is hosted by or otherwise grants access to the distributed ledger management system 102, for example via accessing a particular web endpoint via a browser application on the client system 108. In any such circumstances, in some embodiments a user utilizes authentication credentials to initiate an authenticated session associated with a particular registered asset profile for the asset 301. In various embodiments, the user credentials may limit the user's interaction with the distributed ledger to only the functions authorized to the particular user (or system associated with the user). Such authorization may include limited reading, writing, and/or other editing permissions, which may additionally or alternatively be limited to one or more pieces of data associated with a property identifier and relevant to the user/system. For example, a bank system may only be authorized to edit bank and mortgage related data in the distributed ledger, while an insurance company may only be authorized to edit insurance related data in the distributed ledger. It will be appreciated that the electronic interface may include any number of a myriad of different interface element types to present visualization data associated with data included in the candidate data block 304. For example, in some embodiments, the electronic interface includes one or more text labels, hyperlinks (e.g., where user interaction with the hyperlink initiates rendering of further detail associated with the data underlying the element with which the user interacted), a button, and/or the like.

In another example, the tokenization circuitry 214 can include hardware, software, firmware, and/or a combination thereof, that adds a digital token 312 to a digital wallet 314 based on the candidate data block 304 being added to the distributed ledger 111. The digital wallet 314 can be configured for the property identifier 303. Additionally, the digital wallet 314 can be a digital asset repository accessible by the client system 108 or another computing device for retrieval, storage, and/or management of one or more of digital tokens. In some embodiments, the digital wallet 314 may be stored on a server remotely accessible by the client system 108 or on a memory device on-board the client system 108. In certain embodiments, the digital token 312 can be a non-fungible token (NFT), cryptocurrency, or other type of digital token associated with a digital award, digital imagery, a financial award, a digital recognition, or another type of incentive. In certain embodiments, the digital token 312 can be a redeemable asset associated with a unique network address and/or a redeemable private key. In certain embodiments, the tokenization circuitry 214 can include hardware, software, firmware, and/or a combination thereof, that configure the digital token 312 (e.g., a value of the digital token 312) based on accuracy of data included in the candidate data block 304, a type of data included in the candidate data block 304, and/or a timestamp associated with the candidate data block 304.

### Example Methods

Having described example systems and apparatuses, related data flows, and user interfaces in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depicts a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

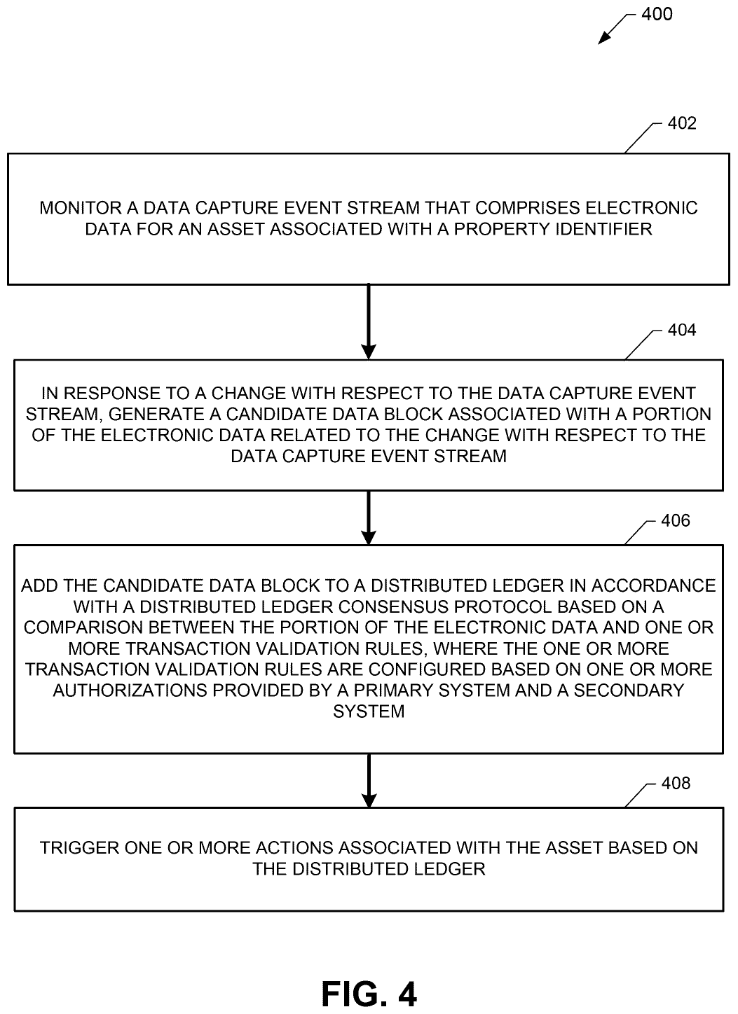

FIG. 4 illustrates a process 400 depicting example operations of an example process for managing electronic data for an asset associated with a property identifier based on a distributed ledger in accordance with at least one embodiment of the present disclosure. The process 400 embodies an example computer-implemented method. In some embodiments, the process 400 is embodied by computer program code stored on a non-transitory computer-readable storage medium of a computer program product configured for execution to perform the process as depicted and described. Alternatively or additionally, in some embodiments, the process 400 is performed by one or more specially configured computing devices, such as the distributed ledger management apparatus 200 alone or in communication with one or more other component(s), device(s), system(s), and/or the like. In this regard, in some such embodiments, the distributed ledger management apparatus 200 is specially configured by computer-coded instructions (e.g., computer program instructions) stored thereon, for example in the memory 204 and/or another component depicted and/or described herein and/or otherwise accessible to the distributed ledger management apparatus 200, for performing the operations as depicted and described. In some embodiments, the distributed ledger management apparatus 200 is in communication with one or more external apparatus(es), system(s), device(s), and/or the like, to perform one or more of the operations as depicted and described. For example, the distributed ledger management apparatus 200 in some embodiments is in communication with a separate primary system, client system, and/or the like. For purposes of simplifying the description, the process 400 is described as performed by and from the perspective of the distributed ledger management apparatus 200.

According to some examples, the process 400 includes monitoring a data capture event stream that comprises electronic data for an asset associated with a property identifier at block 402. According to some examples, the process 400 additionally or alternatively includes, in response to a change with respect to the data capture event stream, generating a candidate data block associated with a portion of the electronic data related to the change with respect to the data capture event stream at block 404. The change with respect to the data capture event stream can be identified based change events associated with the data capture event stream such as, but not limited to, a protection data event, a rights data event, a predefined type of policy change, a predefined type of coverage, a predefined type of renewal or cancelation of a policy, a payment due date and/or receipt of a payment, a predefined type of payee change, a predefined type of LPI event, a predefined type of mortgagee clause change, a predefined type of payoff event, a predefined type of loan change, a predefined type of consent, a predefined type of notice, and/or another type of predefined event capable of occurring with respect to a data capture event stream. According to some examples, the process 400 additionally or alternatively includes adding the candidate data block to a distributed ledger in accordance with a distributed ledger consensus protocol based on a comparison between the portion of the electronic data and one or more transaction validation rules at bock 406, where the one or more transaction validation rules are configured based on one or more authorizations provided by a primary system and a secondary system. According to some examples, the process 400 additionally or alternatively includes triggering one or more actions associated with the asset based on the distributed ledger at block 408.

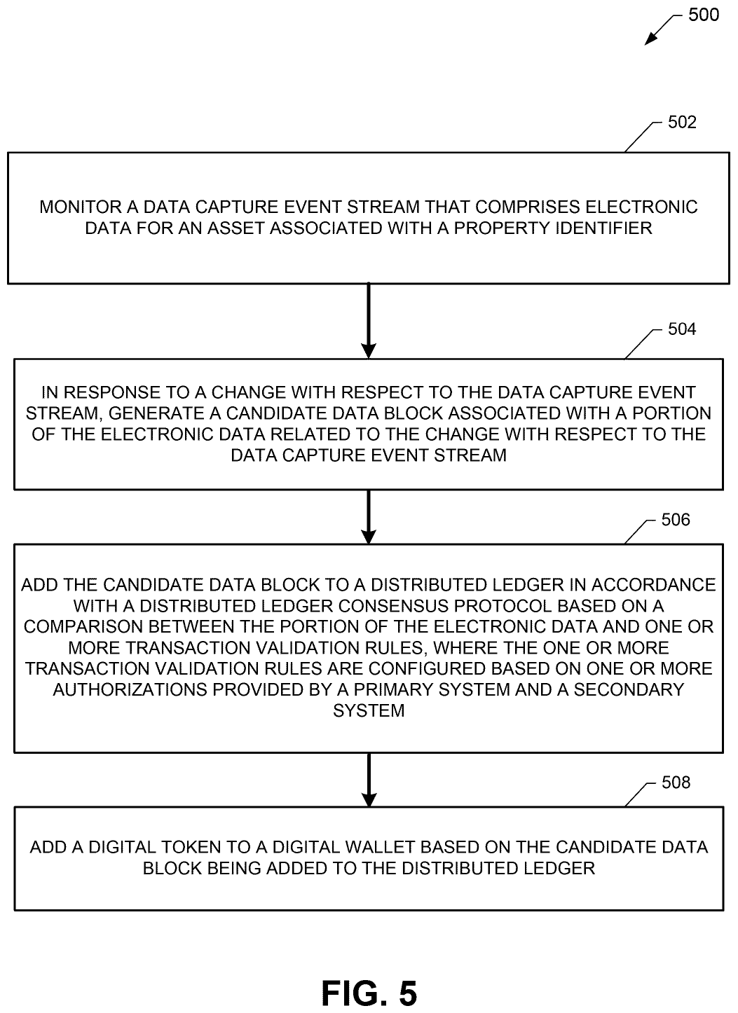

FIG. 5 illustrates a process 500 depicting example operations of an example process for managing digital tokens related to electronic data for an asset associated with a property identifier in accordance with at least one embodiment of the present disclosure. The process 500 embodies an example computer-implemented method. In some embodiments, the process 500 is embodied by computer program code stored on a non-transitory computer-readable storage medium of a computer program product configured for execution to perform the process as depicted and described. Alternatively or additionally, in some embodiments, the process 500 is performed by one or more specially configured computing devices, such as the distributed ledger management apparatus 200 alone or in communication with one or more other component(s), device(s), system(s), and/or the like. In this regard, in some such embodiments, the distributed ledger management apparatus 200 is specially configured by computer-coded instructions (e.g., computer program instructions) stored thereon, for example in the memory 204 and/or another component depicted and/or described herein and/or otherwise accessible to the distributed ledger management apparatus 200, for performing the operations as depicted and described. In some embodiments, the distributed ledger management apparatus 200 is in communication with one or more external apparatus(es), system(s), device(s), and/or the like, to perform one or more of the operations as depicted and described. For example, the distributed ledger management apparatus 200 in some embodiments is in communication with a separate primary system, client system, and/or the like. For purposes of simplifying the description, the process 500 is described as performed by and from the perspective of the distributed ledger management apparatus 200.

According to some examples, the process 500 includes monitoring a data capture event stream that comprises electronic data for an asset associated with a property identifier at block 502. According to some examples, the process 500 additionally or alternatively includes, in response to a change with respect to the data capture event stream, generating a candidate data block associated with a portion of the electronic data related to the change with respect to the data capture event stream at block 504. According to some examples, the process 500 additionally or alternatively includes adding the candidate data block to a distributed ledger in accordance with a distributed ledger consensus protocol based on a comparison between the portion of the electronic data and one or more transaction validation rules at bock 506, where the one or more transaction validation rules are configured based on one or more authorizations provided by a primary system and a secondary system. According to some examples, the process 400 additionally or alternatively includes adding a digital token to a digital wallet based on the candidate data block being added to the distributed ledger at block 508.

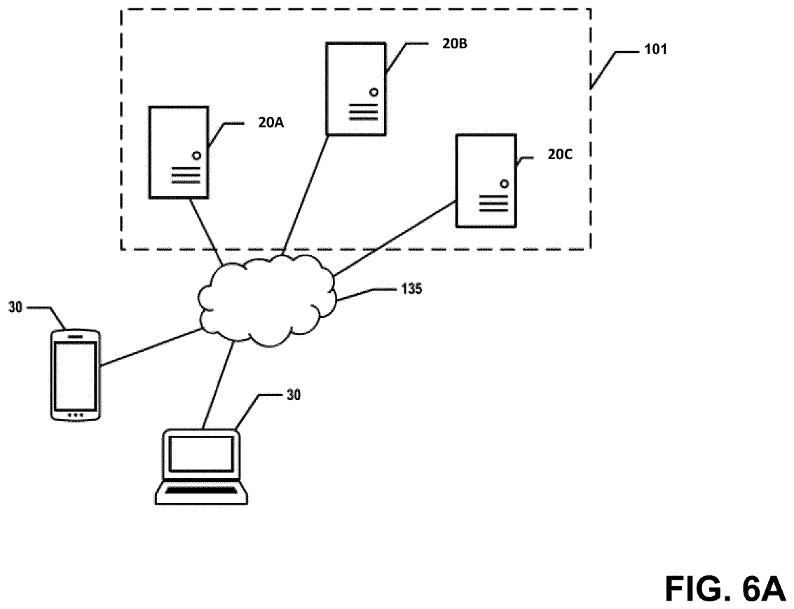

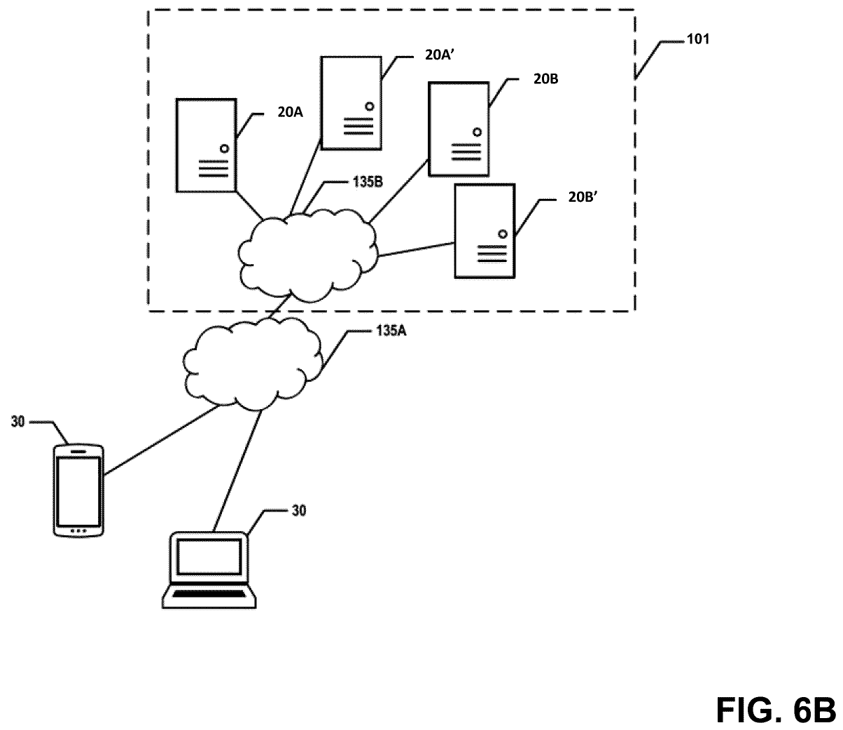

FIG. 6A provides an illustration of a system that can be used in accordance with one or more embodiments of the present disclosure. As shown in FIG. 6A, the system may comprise a distributed platform 101 comprising two or more node computing entities 20 (e.g., 20A, 20B, 20C). In various embodiments, the distributed ledger 111 can be implemented via the two or more node computing entities 20 (e.g., 20A, 20B, 20C). In various embodiments, the distributed ledger 111 can be implemented via the two or more node computing entities 20 (e.g., 20A, 20B, 20C). As shown in FIG. 6A, the system may further comprise one or more non-node computing entities 30, one or more networks 135, and/or the like. In various embodiments, the one or more networks 135 correspond to one or more portions of the network 110 illustrated in FIG. 1.

FIG. 6B provides an illustration of another system that can be used in conjunction with various embodiments of the present invention. As shown in FIG. 6B, the system may comprise a distributed platform 101 comprising two or more node computing entities 20 (e.g., 20A, 20B), 20′ (e.g., 20A′, 20B′), one or more external networks 135A, and/or one or more internal networks 135B. For example, in an example embodiment, the distributed platform 101 comprises a plurality of node computing entities 20, 20′ in communication with one another via a network 135B. In various embodiments, the distributed ledger 111 can be implemented via the two or more node computing entities 20 (e.g., 20A, 20B), 20′ (e.g., 20A′, 20B′). The network 135B may be an internal or private network.

As shown in FIG. 6B, the system may further comprise one or more non-node computing entities 30, one or more other and/or external networks 135A, and/or the like. For example, the other and/or external network 135A may be external, public, and/or a different network from the internal and/or private network 135B. In various embodiments, the one or more external networks 135A correspond to one or more portions of the network 110 illustrated in FIG. 1. Each of the components of the system may be in electronic communication with, for example, one another over the same or different wireless or wired networks 135 including, for example, a wired or wireless PAN, LAN, MAN, WAN, or the like. Additionally, while FIGS. 6A and/or 6B illustrate certain system entities as separate, standalone entities, the various embodiments are not limited to this particular architecture.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus comprising one or more processors and one or more storage devices storing instructions that are operable, when executed by the one or more processors, to cause the one or more processors to:
monitor a data capture event stream that comprises electronic data for an asset associated with a property identifier;
in response to a change with respect to the data capture event stream, generate a candidate data block associated with a portion of the electronic data related to the change with respect to the data capture event stream;
add the candidate data block to a distributed ledger in accordance with a distributed ledger consensus protocol based on a comparison between the portion of the electronic data and one or more transaction validation rules, wherein the one or more transaction validation rules are configured based on one or more authorizations provided by a primary system and a secondary system; and
trigger one or more actions associated with the asset based on the distributed ledger.

2. The apparatus of claim 1, wherein the one or more storage devices store instructions that are operable, when executed by the one or more processors, to further cause the one or more processors to:
cause execution of a smart contract of the distributed ledger to add the candidate data block to the distributed ledger in accordance with the distributed ledger consensus protocol.

3. The apparatus of claim 1, wherein the one or more storage devices store instructions that are operable, when executed by the one or more processors, to further cause the one or more processors to:
generate the candidate data block in response to a transaction associated with the data capture event stream; and
configure the candidate data block for the distributed ledger based on transaction information related to the transaction.

4. The apparatus of claim 1, wherein the one or more storage devices store instructions that are operable, when executed by the one or more processors, to further cause the one or more processors to:
generate the candidate data block in response to a protection data event associated with the data capture event stream; and
configure the candidate data block for the distributed ledger based on insurance information related to the protection data event.

5. The apparatus of claim 1, wherein the one or more storage devices store instructions that are operable, when executed by the one or more processors, to further cause the one or more processors to:
generate the candidate data block in response to a rights data event associated with the data capture event stream; and
configure the candidate data block for the distributed ledger based on mortgage information related to the rights data event.

6. The apparatus of claim 1, wherein the one or more storage devices store instructions that are operable, when executed by the one or more processors, to further cause the one or more processors to:
configure the candidate data block for the distributed ledger with the property identifier.

7. The apparatus of claim 1, wherein the one or more storage devices store instructions that are operable, when executed by the one or more processors, to further cause the one or more processors to:
correlate the property identifier to a sequence of formatted data that uniquely identifies the asset; and
configure the candidate data block for the distributed ledger based on the sequence of formatted data.

8. The apparatus of claim 1, wherein the one or more storage devices store instructions that are operable, when executed by the one or more processors, to further cause the one or more processors to:
identify a change with respect to the data capture event stream based on an application program interface (API) call.

9. The apparatus of claim 1, wherein the one or more storage devices store instructions that are operable, when executed by the one or more processors, to further cause the one or more processors to:
trigger an application program interface (API) call based on the candidate data block being added to the distributed ledger.

10. The apparatus of claim 1, wherein the one or more storage devices store instructions that are operable, when executed by the one or more processors, to further cause the one or more processors to:
based on the candidate data block being added to the distributed ledger, render visualization data associated with the electronic data via an electronic interface of a computing device.

11. The apparatus of claim 1, wherein the one or more storage devices store instructions that are operable, when executed by the one or more processors, to further cause the one or more processors to:
add a digital token to a digital wallet associated with the property identifier based on the candidate data block being added to the distributed ledger.

12. The apparatus of claim 11, wherein the one or more storage devices store instructions that are operable, when executed by the one or more processors, to further cause the one or more processors to:
configure a value of the digital token based on accuracy of data included in the candidate data block.

13. The apparatus of claim 11, wherein the one or more storage devices store instructions that are operable, when executed by the one or more processors, to further cause the one or more processors to:
configure a value of the digital token based on a timestamp associated with the candidate data block.

14. A computer-implemented method, comprising:
monitoring a data capture event stream that comprises electronic data for an asset associated with a property identifier;
in response to a change with respect to the data capture event stream, generating a candidate data block associated with a portion of the electronic data related to the change with respect to the data capture event stream;
adding the candidate data block to a distributed ledger in accordance with a distributed ledger consensus protocol based on a comparison between the portion of the electronic data and one or more transaction validation rules, wherein the one or more transaction validation rules are configured based on one or more authorizations provided by a primary system and a secondary system; and
triggering one or more actions associated with the asset based on the distributed ledger.

15. The computer-implemented method of claim 14, further comprising:
causing execution of a smart contract of the distributed ledger to add the candidate data block to the distributed ledger in accordance with the distributed ledger consensus protocol.

16. The computer-implemented method of claim 14, further comprising:
generating the candidate data block in response to a transaction associated with the data capture event stream; and
configuring the candidate data block for the distributed ledger based on transaction information related to the transaction.

17. The computer-implemented method of claim 14, further comprising:
generating the candidate data block in response to a protection data event associated with the data capture event stream; and
configuring the candidate data block for the distributed ledger based on insurance information related to the protection data event.

18. The computer-implemented method of claim 14, further comprising:
generating the candidate data block in response to a rights data event associated with the data capture event stream; and
configuring the candidate data block for the distributed ledger based on mortgage information related to the rights data event.

19. The computer-implemented method of claim 14, further comprising:
configuring the candidate data block for the distributed ledger with the property identifier.

20-26. (canceled)

27. A computer program product, stored on a computer readable medium, comprising instructions that when executed by one or more computers cause the one or more computers to:
monitor a data capture event stream that comprises electronic data for an asset associated with a property identifier;
in response to a change with respect to the data capture event stream, generate a candidate data block associated with a portion of the electronic data related to the change with respect to the data capture event stream;
add the candidate data block to a distributed ledger in accordance with a distributed ledger consensus protocol based on a comparison between the portion of the electronic data and one or more transaction validation rules, wherein the one or more transaction validation rules are configured based on one or more authorizations provided by a primary system and a secondary system; and
trigger one or more actions associated with the asset based on the distributed ledger.

28-39. (canceled)
